(19) United States
(12) Patent Application Publication
(10) Pub. No.: US 2026/0170745 A1
(43) Pub. Date: Jun. 18, 2026

(54) ENERGY-EFFICIENT NEURAL GRAPHICS ACCELERATOR AND METHOD THEREOF

(71) Applicant: Korea Advanced Institute of Science and Technology, Daejeon (KR)

(72) Inventors: Hoi Jun YOO, Daejeon (KR); Jun Ha RYU, Daejeon (KR)

(73) Assignee: Korea Advanced Institute of Science and Technology, Daejeon (KR)

(21) Appl. No.: 19/072,957

(22) Filed: Mar. 6, 2025

(30) Foreign Application Priority Data
Dec. 13, 2024 (KR) 10-2024-0185506

(51) Int. Cl. G06T 15/00; G06T 9/00; G06T 15/06

(52) U.S. Cl. CPC G06T 15/005; G06T 9/001; G06T 15/06; G06T 2210/36; G06T 2210/52

(57) ABSTRACT

Provided is a neural graphics accelerator, which accelerates a 3D image using a NeRF model based on hash encoding, including an SMU that divides a virtual 3D space into a plurality of subblocks, and then generates, stores, and manages 3D samples in units of subblocks, and n core clusters that acquires color and density for each 3D sample by performing modeling and rendering on the 3D samples, wherein each core cluster includes an AHIU that performs hash encoding on the 3D samples through preprocessing with skipping vertices applied to the 3D samples and a trilinear interpolation operation using a heterogeneous operator, and m operation cores that skips all input channels whose values are all 0 or input channels all having similar values by a coarse-grained skipping operation to accelerate both modeling and rendering, thereby calculating color and density of each 3D sample.

### CROSS-REFERENCE TO RELATED APPLICATION

This application claims the benefit of priority under 35 U.S.C. §119(a) to Korean Patent Application No. 10-2024-0185506, filed on December 13, 2024, the entire contents of which are incorporated herein by reference.

### BACKGROUND OF THE INVENTION

The present invention relates to an energy-efficient neural graphics accelerator and a method thereof, and more particularly to an energy-efficient neural graphics accelerator and a method thereof for performing instantaneous three-dimensional (3D) modeling and high-speed rendering on a mobile device.

With the development of the digital twin and the metaverse, there is expanding demand for 3D modeling and rendering technologies capable of replicating real-world entities in augmented or virtual environments.

In this regard, 3D modeling using a neural radiance field (NeRF) has been widely used recently (B. Mildenhall et al., "Nerf: Representing scenes as neural radiance fields for view synthesis," in ECCV, 2020). The NeRF trains a deep neural network (DNN) using several two-dimensional (2D) images as a ground truth, thereby encoding real-world information of an object or environment into parameters of the DNN. After 3D modeling is completed, a rendering result of a 3D model in a new arbitrary view may be obtained through an inference process of a DNN model.

In this way, the NeRF has an advantage of being able to easily create a 3D model by only training a DNN using 2D images without manual design of a user and an expensive scanning studio. In addition, the NeRF may be shared among metaverse users and has a feature of being able to perform various artificial intelligence (AI) applications.

However, due to frequent memory access and computational volume of neural graphics algorithms, there has been a problem of inefficiency in applying NeRF technology to edge and mobile environments.

Therefore, even though there has been hardware that accelerates NeRF technology so that this NeRF technology could be applied to the edge/mobile environments (D. Han et al., "MetaVRain: A Mobile Neural 3-D Rendering Processor With Bundle-Frame-Familiarity-Based NeRF Acceleration and Hybrid DNN Computing," IEEE Journal of Solid-State Circuits, vol. 59, no. 1, pp. 65-78, 2024), this method could only accelerate inference (rendering) of a trained 3D model. That is, since the target NeRF model of this work (MetaVRain) includes only several layers of MLP (Multi-Layer Perceptron), a convergence speed during training (modeling) is significantly low. Therefore, even when the conventional technology (D. Han et al., "MetaVRain: A Mobile Neural 3-D Rendering Processor With Bundle-Frame-Familiarity-Based NeRF Acceleration and Hybrid DNN Computing," IEEE Journal of Solid-State Circuits, vol. 59, no. 1, pp. 65-78, 2024) is applied, instantaneous 3D model generation is impossible (it takes 1 to 2 days on a server-scale GPU).

Recently, a NeRF model based on hash encoding has been introduced to shorten a modeling time (T. M¨uller et al., "Instant neural graphics primitives with a multiresolution hash encoding," ACM Trans. Graph., vol. 41, no. 4, pp. 102:1-102:15, Jul. 2022). This method improves a convergence speed by explicitly storing information of a 3D model in hash embedding at each adjacent location by utilizing multi-resolution hash embedding. However, despite improvement of this algorithm, there is a problem that it is difficult to apply the NeRF technology to edge and mobile environments to perform instantaneous 3D modeling or high-speed rendering.

The following analyzes specific reasons for not being able to effectively shorten a modeling and rendering time even when the NeRF model based on hash encoding is used in this way.

First, the NeRF model based on hash encoding has a large number of parameters, which is more than 23 MB, while a typical L2 cache of an edge-oriented GPU is not sufficient to store even one level of hash embedding. In addition, an irregular memory access pattern caused by a hash function increases cache misses, and small byte-unit (4 Bytes) memory access wastes an external memory bandwidth, causing large off-chip memory access that consumes 90.0% of system energy when performing modeling.

Second, on-chip memory access for a trilinear interpolation operation of hash encoding suffers from throughput degradation caused by bank conflict. That is, during the corresponding process, several parallel keys are mapped to a hash function to generate hash embedding access addresses, which causes bank conflict where different keys access the same memory back. As a result, throughput is degraded. A reason therefor is that only a single address may access a static random access memory (SRAM) bank at a time. When the number of banks is increased to increase an on-chip memory bandwidth to address this problem, bank conflict may be alleviated. However, this incurs large power consumption (80% or more) along with area overhead due to many banks.

Third, the NeRF model based on hash encoding shows a low input sparsity ratio due to a small number of layers. Therefore, when a fine-sparsity-skipping architecture is applied to the NeRF based on hash encoding, energy efficiency is low. In addition, in the NeRF based on hash encoding, MLP is the dominant operation accounting for 90% or more of the entire operation. This large amount of operation lowers a rendering speed.

In summary, due to the above-mentioned three hardware bottlenecks, when the NeRF model based on hash encoding is applied to a mobile-oriented GPU platform, there is a problem that 3D modeling takes 10 minutes or more and a rendering speed is 1 frame per second or less, which is low.

### SUMMARY OF THE INVENTION

The present invention has been made to solve the above-described problems, and aims to provide an energy-efficient neural graphics accelerator and a method thereof enabling instantaneous 3D modeling and high-speed rendering simultaneously even in an edge/mobile environment having limited resources by improving a memory access inefficiency and the amount of operation of a neural graphics algorithm.

In addition, the present invention provides an energy-efficient neural graphics accelerator and a method thereof, which may significantly reduce memory usage and improve memory efficiency by dividing hash embedding of each level into several segments and storing the divided segments completely in an on-chip memory of proposed hardware architecture, and may minimize external memory access.

In addition, the present invention provides an energy-efficient neural graphics accelerator and a method thereof capable of processing hash embedding in units of segments in parallel due to reduction in memory usage as described above, thereby shortening rendering/modeling operation time to enable rapid acceleration of a NeRF model based on hash encoding even in edge and mobile environments.

In addition, the present invention provides an energy-efficient neural graphics accelerator and a method thereof capable of increasing throughput by skipping interpolation operation for a node contributing less to a final result based on approximate properties of trilinear interpolation.

In addition, the present invention provides an energy-efficient neural graphics accelerator and a method thereof that process operation by a different operation unit for each level of hash embedding during a trilinear interpolation operation of hash encoding, maximize data reuse through parallel processing using a cache at a coarse-grid level, and perform serial processing without using a cache at a fine-grid level, thereby being able to maximize data reuse, alleviate bank conflict, and, as a result, solve a problem of throughput degradation caused by bank conflict.

In addition, the present invention provides an energy-efficient neural graphics accelerator and a method thereof capable of improving energy efficiency by applying a coarse-grained skipping method, which skips operations of both similar data and sparse data during MLP operation.

In accordance with an aspect of the present invention, the above and other objects can be accomplished by the provision of a neural graphics accelerator configured to accelerate a three-dimensional (3D) image using a neural radiance field (NeRF) model based on hash encoding, the neural graphics accelerator including a spatial management unit (SMU) configured to divide a virtual 3D space into a plurality of subblocks, and then generate, store, and manage 3D samples in units of subblocks, and n core clusters (here, n is a natural number, which is applied hereinafter) configured to acquire color and density for each of the 3D samples by performing modeling and rendering on the 3D samples, wherein each of the core clusters includes an attention-based hybrid interpolation unit (referred to hereinafter as "AHIU") configured to perform hash encoding on the 3D samples through preprocessing with skipping vertices applied to the 3D samples and a trilinear interpolation operation using a heterogeneous operator, and m operation cores (S³ Cores) configured to skip all input channels whose values are all 0 or input channels all having similar values by a coarse-grained skipping operation to accelerate both modeling and rendering, thereby calculating color and density of each of the 3D samples.

The SMU may include a plurality of sample generators (SGs) configured to generate a sample for the 3D space and generate sample coordinates through ray casting while checking a valid space using a coarse bitmap representing an occupancy state of each of the subblocks and a hierarchical bitmap for encoding a fine bitmap for an interior of the subblocks, a ray address table (RAT) configured to store a feature map for each ray, which is information on a plurality of subblocks through which one ray passes for the ray casting, and a block ordering unit (BOU) configured to determine a processing order of each of the subblocks through depth-first search-based topological sorting.

The RAT may store address information dynamically allocated to the feature map for each ray using a linked list format.

The RAT may compress and store address information allocated to each of a plurality of rays grouped into patches in units of patches.

The BOU may determine a depth of each of the subblocks through sparse ray casting, and then determine a processing order to process a subblock having a lower depth first.

In a case of a duplicate subblock that is a subblock through which one or more rays pass, the BOU may determine a deeper value among depths determined by the one or more rays, respectively, as a depth of the duplicate subblock.

The AHIU may include a preprocessor configured to calculate eight vertex indices (IDs) from sample coordinates for each of the 3D samples, then determine skip vertices which are vertices allowed to be skipped by distances between the sample coordinates and the eight vertices, and manage information thereof, and an interpolation operation unit configured to perform a trilinear interpolation operation using different heterogeneous operators for each hash embedding level including a coarse-grid level and a fine-grid level.

The interpolation operation unit may include a parallel interpolation unit including an embedding cache designed as a register so as to simultaneously process several inputs, and configured to process several input addresses at once without conflict by connecting all inputs of the embedding cache to a parallel MAC, thereby operating at the coarse-grid level, and a serial interpolation unit exclusively including an HTMEM (Hash Table MEMory), and configured to serially process one address at a time using a single MAC, thereby operating at the fine-grid level.

Each of the operation cores (S³ Cores) may include 16 x 16 processing elements (PEs), an input/output memory (IOMEM) including two bank groups to simultaneously perform input and output, an index memory (IDXMEM) configured to store a skip index, which is an index of an input channel skipped in a previous layer, a weight memory (WMEM) configured to store a weight of an input channel, a weight prefetcher configured to preload a weight of an input channel not skipped from the WMEM based on the skip index and supply the preloaded weight to the PEs when replacing the weight, a partial sum memory (PSMEM) configured to accumulate partial sums by a MAC operation using an addition tree in units of columns of the PEs, and a similarity-sparsity compression unit (SSCU) configured to analyze similarity and sparsity of a result accumulated in the PSMEM, compress the result accumulated in the PSMEM based on a result thereof, and store the result in the IOMEM.

The SSCU may include a similarity check unit configured to compare a result accumulated in the PSMEM with a preset similarity range, a state register configured to store a processing result of the similarity check unit, a step generator configured to calculate a number of steps for compression using information stored in the state register, and a crossbar network configured to convert the result accumulated in the PSMEM into a compressed form based on information stored in the state register and the number of steps.

In accordance with another aspect of the present invention, there is provided a method of accelerating neural graphics using a neural graphics accelerator configured to accelerate a 3D image using a NeRF model based on hash encoding, the method including generating, by the neural graphics accelerator, 3D samples in units of subblocks after dividing a virtual 3D space into a plurality of subblocks, storing, by the neural graphics accelerator, a feature map for each ray which is information on a plurality of subblocks through which one ray passes for ray casting, determining, by the neural graphics accelerator, a processing order of each of the subblocks through depth-first search-based topological sorting, and performing, by the neural graphics accelerator, modeling and rendering on the 3D samples, wherein the performing modeling and rendering includes performing preprocessing with skipping vertices applied to the 3D samples, performing a trilinear interpolation operation using a heterogeneous operator, and accelerating both modeling and rendering by skipping all input channels whose values are all 0 or input channels all having similar values by a coarse-grained skipping operation.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of an energy-efficient neural graphics accelerator according to an embodiment of the present invention;

FIG. 2 is a diagram illustrating an operation of an SMU of the neural graphics accelerator according to an embodiment of the present invention;

FIG. 3 is a diagram for describing an operation and a configuration of a sample generator (SG) according to an embodiment of the present invention;

FIG. 4 is a diagram for describing an operation and a configuration of a ray address table (RAT) according to an embodiment of the present invention;

FIG. 5 is a diagram for describing an operation and a configuration of a block ordering unit (BOU) according to an embodiment of the present invention;

FIG. 6 and FIG. 7 are diagrams for describing a configuration of an attention-based hybrid interpolation unit (AHIU) according to an embodiment of the present invention;

FIG. 8 is a graph illustrating memory access characteristics of a hash-based NeRF to which an interpolation operation unit according to an embodiment of the present invention is applied;

FIG. 9 is a diagram for describing an operation process of an operation core (S³ Core) to which a coarse-grained skipping method according to an embodiment of the present invention is applied;

FIG. 10 and FIG. 11 are schematic block diagrams of the operation core (S³ Core) according to an embodiment of the present invention;

FIG. 12 is a diagram for describing an operation and a configuration of an SSCU according to an embodiment of the present invention; and

FIG. 13 to FIG. 17 are processing flowcharts for an energy-efficient neural graphics acceleration method according to an embodiment of the present invention.

### DETAILED DESCRIPTION OF THE INVENTION

Hereinafter, embodiments of the present invention will be described with reference to the attached drawings, and will be described in detail so that those skilled in the art may easily practice the present invention. However, the present invention may be implemented in many different forms and is not limited to the embodiments described herein. Meanwhile, to clearly describe the present invention in the drawings, parts unrelated to the description are omitted, and similar parts are given similar reference numerals throughout the specification. In addition, descriptions of parts, which may be easily understood by those skilled in the art even when detailed descriptions are omitted, are omitted.

Throughout the specification and claims, when a part is described as including a certain component, this means that other components may be further included rather than excluding other components, unless specifically stated to the contrary.

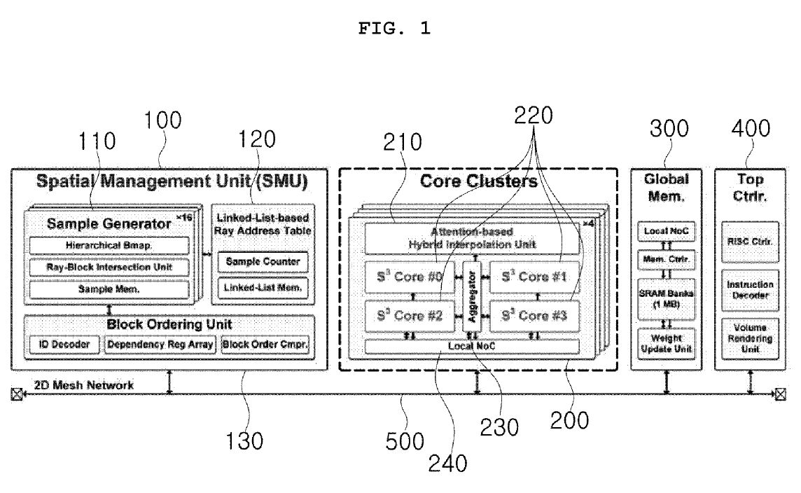

FIG. 1 is a schematic block diagram of an energy-efficient neural graphics accelerator according to an embodiment of the present invention. Referring to FIG. 1, the energy-efficient neural graphics accelerator according to the embodiment of the present invention includes an SMU 100, a plurality of core clusters 200, a global memory (GM) 300, and a top controller (TC) 400, and all the cores 100, 200, 300, and 400 may be connected to a 2D-mesh type interconnect network 500.

The SMU 100 divides a virtual 3D space into a plurality of subblocks, and then generates, stores, and manages 3D samples in units of subblocks. To this end, the SMU 100 includes a plurality of SGs 110 that encodes/decodes 3D spatial information through ray casting, a linked-list-based ray address table (LRAT) 120 that stores distributed addresses of blocks, and a BOU 130 that arranges a processing order of blocks, and supports a segmented hashing with spatial pruning (SHSP) operation. In this instance, the number of SGs 110 is set in response to throughput of the core clusters 200 to be described later, and should be designed so that a bottleneck does not occur in a processing process of the entire system. An example of FIG. 1 is an example in which there are four core clusters 200, and thus 16 SGs 110 are configured.

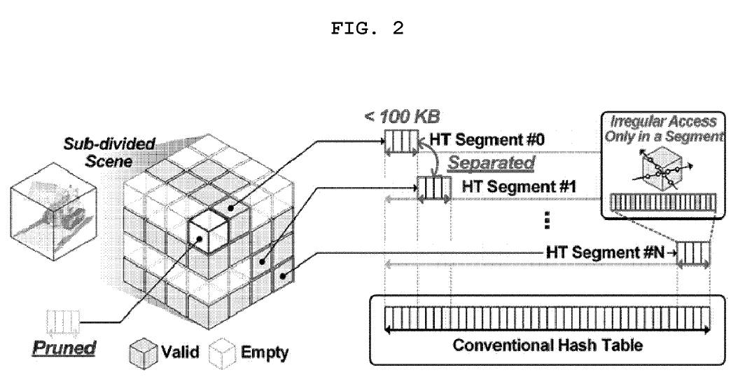

An operation and a configuration of the SMU 100 will be described later with reference to FIGS. 2 to 5.

The core clusters 200 perform modeling and rendering on each of 3D samples generated by the SMU 100 to acquire color and density for each of the 3D samples. To this end, each of the core clusters 200 includes an AHIU 210, four operation cores (S³ Cores) 220, and an aggregator 230, and all the units 210, 220, and 230 in the core cluster 200 are connected to an on-chip local network (Local NoC) 240. In this instance, the numbers of the core clusters 200 and operation cores 220 may be determined by the integrable chip area. The example of FIG. 1 illustrates that four core clusters 200 and four operation cores 220 are configured.

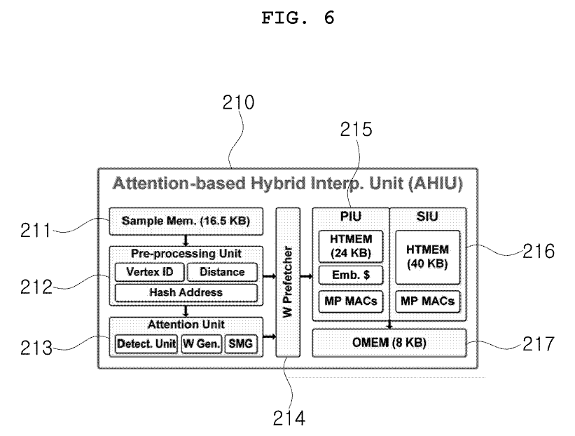

The AHIU 210 performs hash encoding on the 3D samples through preprocessing with skipping vertices applied to the 3D samples and trilinear interpolation using a heterogeneous operator. An operation and a configuration of the AHIU 210 therefor will be described later with reference to FIGS. 6 to 8.

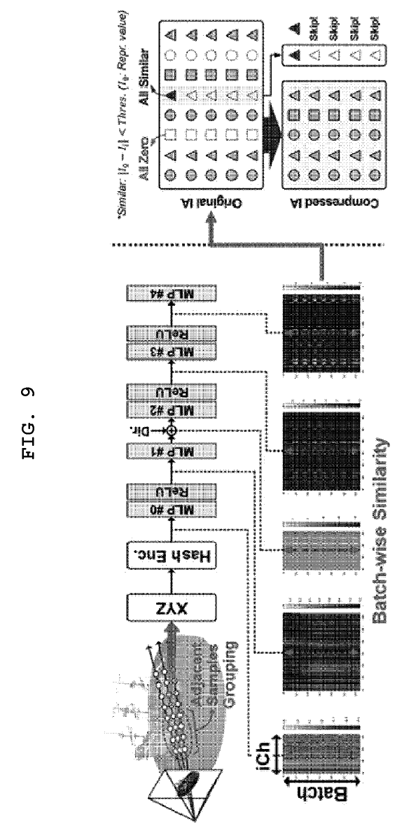

Each of the four operation cores (S³ Cores) 220 skips all input channels whose values are all 0 (that is, input channels having sparsity) or input channels all having similar values (that is, input channels having similarity) by a coarse-grained skipping operation to accelerate both modeling and rendering, thereby calculating color and density of each of the 3D samples. An operation and a configuration of the operation cores (S³ Cores) 220 therefor will be described later with reference to FIGS. 9 to 12.

The aggregator 230 sums gradients for the respective four operation cores (S³Cores) 220 illustrated in FIG. 1 in a modeling scenario.

The GM 300 stores various types of information for the operation of the neural graphics accelerator of the present invention. That is, the GM 300 includes 1 MB SRAM and a weight update device for training parameters of hash embedding and MLP, and may store gradients of parameters, intermediate feature vectors, rough and fine 3D bitmaps, and sample coordinates. In particular, the GM 300 receives a result of the sum of gradients for the respective four operation cores (S³ Cores) 220 from the aggregator 230 and stores the result.

The TC 400 controls the overall operation of the neural graphics accelerator of the present invention. To this end, the TC 400 may include a RISC controller (RISC Ctrlr.), an instruction decoder, and a volume rendering unit. In particular, the volume rendering unit may perform a weighted sum operation to obtain a final pixel color from output results of several samples.

Meanwhile, all operations win the neural graphics accelerator of the present invention may be fully pipelined to improve throughput and energy efficiency of NeRF-based modeling and rendering.

FIG. 2 is a diagram illustrating an operation of the SMU of the neural graphics accelerator according to an embodiment of the present invention, and schematically describes a hash embedding memory access optimization process.

Referring to FIGS. 1 and 2, the SMU 100 divides a 3D space into several subblocks and allocates a separate hash table segment to each subblock. That is, the SMU 100 performs SHSP, which partitions a 3D space into several subblocks and causes each subblock to have a separate hash table (embedding) segment, thereby preventing irregular memory access of hash encoding and increasing computational intensity.

A reason therefor is to solve the conventional problem that, when performing trilinear interpolation during hash encoding, an input sample generates a large number of unpredictable memory addresses, but a cache in a chip cannot store the entire hash embedding (that is, a hash table (HT)), resulting in frequent cache misses and frequent irregular off-chip memory access.

That is, the SMU 100 segments a hash table in units of subblocks so that the segmented hash table is completely stored on-chip at less than or equal to 100 kB including the entire level. In this way, irregular access by the hash function occurs only in a segment, so that irregular off-chip memory access occurring during conventional hash encoding may be completely eliminated.

In addition, the SMU 100 allocates a different hash table segment to each subblock, so that, when samples collected by ray casting are located in different subblocks, different hash table segments are allocated to the corresponding samples, and as a result, data conflict may be prevented by accessing different hash table segments for the operation of each subblock during a trilinear interpolation operation.

In addition, in the past, data reuse could not be achieved since several samples from different rays repeatedly accessed a single hash table, which resulted in low computational intensity (computation per byte) and a problem of hindering the entire modeling and rendering process limited by memory bandwidth. However, the present invention may maximize computational intensity by collecting samples located in the same block in advance and then performing hash encoding.

In addition, since the SMU 100 generates, stores, and manages 3D samples in units of a plurality of subblocks in a single 3D space, several empty subblocks may be present in the single 3D space, and operations on these empty subblocks may be omitted.

Therefore, the SMU 100 may prune segments of empty space (that is, empty subblocks) and store the hash table only in a valid block, which enables SMU 100 to reduce both the memory usage of hash embedding and computation of duplicate samples.

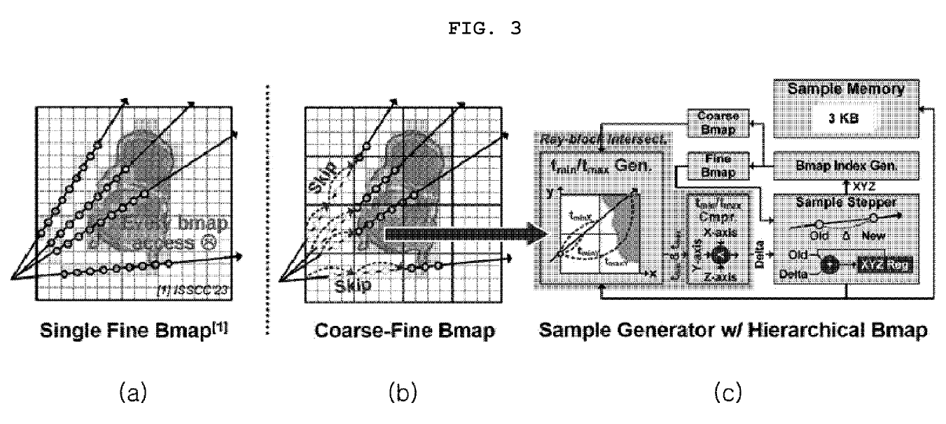

FIG. 3 is a diagram for describing an operation and a configuration of an SG according to an embodiment of the present invention, and schematically describes an operation and a configuration of an SG that generates a sample for the 3D space and generates sample coordinates through ray casting while checking a valid space using a coarse bitmap representing an occupancy state of each of the subblocks and a hierarchical bitmap for encoding a fine bitmap for an interior of the subblocks.

FIG. 3A is a diagram schematically describing a conventional single fine bitmap process. Referring to FIG. 3A, in the past, when a sample was generated, a single fine bitmap was used, so that a single bitmap had to be repeatedly accessed to perform empty space skipping. As a result, in the past, there has been a disadvantage of requiring a long delay time and frequent bitmap memory access.

FIG. 3B is a diagram schematically describing a coarse-fine bitmap process of the SG 110. Referring to FIG. 3B, the SG 110 of the present invention uses a hierarchical bitmap (coarse-fine bitmap) to efficiently encode information of a 3D space. That is, the SG 110 utilizes a hierarchical bitmap that hierarchically encodes two bitmaps, namely, coarse and fine bitmaps, and displays an occupancy state of a coarse map to indicate 0 (empty space) when all data of the fine bitmap in the block is 0, thereby enabling generation of sample coordinates through ray casting while checking a valid space. In this way, it is possible to avoid avoiding unnecessary fine bitmap encoding for an empty block, thereby accelerating a ray casting speed.

FIG. 3C is a diagram illustrating a structure of the SG 110. Referring to FIG. 3C, the SG 110 includes a sample memory for storing sampled coordinates for encoding work, a bitmap index generator for generating a hierarchical bitmap index, a ray-block intersection unit, and a sample stepper. When a coarse bitmap in the SG 110 is detected as 0 during ray casting, the ray-block intersection unit calculates a step, and the sample stepper updates the sample coordinates. In addition, the sampled coordinates at this time are stored in the sample memory for subsequent hash encoding work.

For this reason, the SG 110 of the present invention may achieve bitmap compression of 5.5 times on average, and in addition to this bitmap compression, the SG 110 may provide a ray casting speed that is 3.67 times faster on average through a hierarchical bitmap.

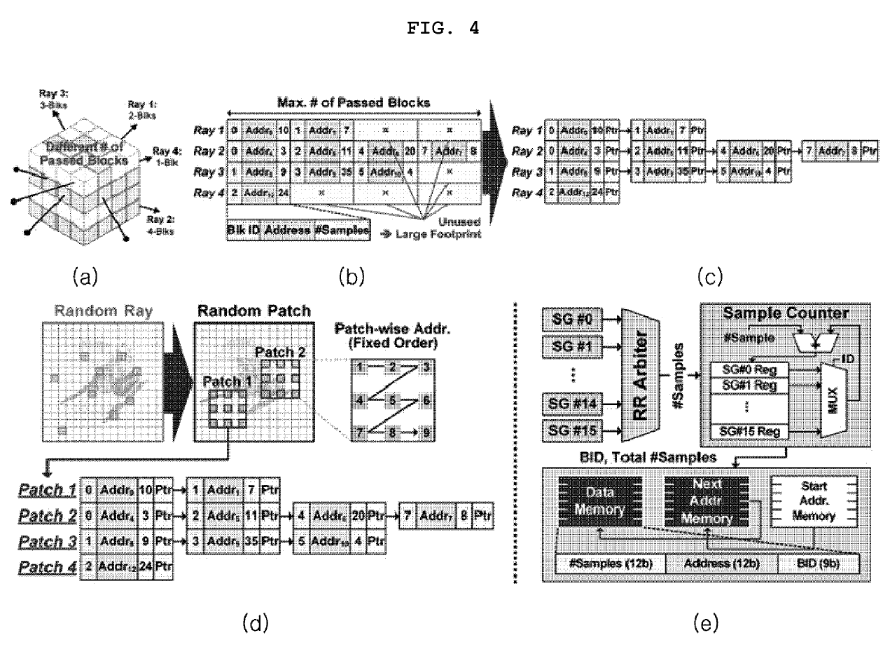

FIG. 4 is a diagram for describing an operation and a configuration of a ray address table (RAT) according to an embodiment of the present invention, and schematically describes a process and a structure for generating an RAT that stores a feature map for each ray, which is information on a plurality of subblocks through which one ray passes for ray casting.

FIG. 4A is a diagram schematically illustrating a state in which a plurality of rays passes through a single 3D space divided into a plurality of subblocks, FIG. 4B illustrates a state in which addresses of subblocks through which the respective rays illustrated in FIG. 4A pass (hereinafter, referred to as address information for each ray or a feature map for each ray) are arranged for each ray, FIG. 4C illustrates a state in which the feature map for each ray arranged as illustrated in FIG. 4B is implemented as a linked list-based table, which is an example in which address information dynamically allocated to the feature map for each ray is compressed and stored using a linked list format, FIG. 4D illustrates an example in which the linked list-based table illustrated in FIG. 4C is compressed and stored again in units of patches when using a ray sampling method in units of patches as illustrated in the figure, and FIG. 4E illustrates a structure of the LRAT 120 therefor.

Referring to FIG. 4A, when hash encoding is performed by passing a plurality of rays through a single 3D space divided into a plurality of subblocks, address information for each passed subblock for each ray is scattered in the memory space. Therefore, it is essential to manage the address information stored in order to perform a subsequent MLP operation.

FIG. 4B illustrates a state in which a feature map address for each ray is simply sorted to manage these addresses. In this case, wasted memory space (area indicated by x) occurs due to the imbalance in the number of blocks through which each ray passes. Therefore, depending on the size of this wasted memory space, a large on-chip memory may be required. For example, an on-chip memory of 300 kB or more may be used.

FIG. 4C illustrates an example of dynamically allocating the feature map address for each ray in a linked list format to reduce such memory usage. To generate such a linked list-based RAT, a sample counter illustrated in FIG. 4E accumulates the number of samples of each SG 110 and transfers the total number of samples and a current block ID to the RAT. In this case, a data memory that stores a 9-bit block ID, a 12-bit address, and a 12-bit number-of-samples, respectively, is updated with the corresponding information, and the corresponding information is used thereafter when accessing an address of a required ray. In this way, the present invention may reduce memory usage by 44.6%.

FIG. 4D illustrates a method for further compressing and storing such a linked list-based RAT, in which the SG 110 performs sampling by dilated patch-wise ray sampling that replaces a previous random ray sampling method, and groups a plurality of rays used at this time into patches to manage address information in units of patches, thereby reducing the number of linked list items. In this case, the present invention may additionally reduce memory usage by 88.3%.

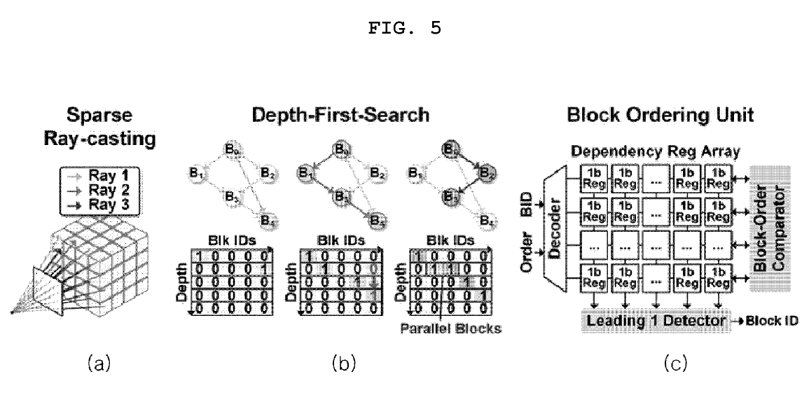

FIG. 5 is a diagram for describing an operation and a configuration of a BOU according to an embodiment of the present invention, and schematically describes a processing process and a structure of the BOU that determines a processing order of each of the subblocks through depth-first search-based topological sorting.

FIG. 5A illustrates a state in which three rays (Ray 1, Ray 2, and Ray 3) are projected for sparse ray casting, FIG. 5B illustrates a state recorded in a dependency register array (DRA) for managing the order and dependency of each subblock by the order of the subblocks through which the respective three rays (Ray 1, Ray 2, and Ray 3) pass, and FIG. 5C illustrates an example of a configuration of the BOU 130 including the DRA and a detector (Leading 1 Detector) that sequentially detects one subblock ID from the DRA.

In this instance, the BOU 130 utilizes Early Ray Termination to omit computation of unnecessary samples. Early Ray Termination is used in most NeRF technologies and enables avoidance of unnecessary computation of invisible samples when the transmittance falls to a threshold or less. Therefore, by processing blocks close to the camera origin first, the benefit of Early Ray Termination may be maximized, and 57.6% of redundant samples may be removed from a synthetic NeRF dataset.

Accordingly, the BOU 130 determines the processing order of each of the subblocks through depth-first search-based topological sorting. That is, the BOU 130 determines the depth of each of the subblocks through sparse ray casting, and then determines the processing order to process a subblock having a lower depth first. However, in the case of a duplicate subblock that is a subblock through which one or more rays pass, a deeper value among depths determined by the one or more rays, respectively, may be determined as the depth of the duplicate subblock.

First, referring to FIG. 1 and FIGS. 5A, 5B, and 5C, the BOU 130 first simply sorts the order of blocks and detects independent parallel blocks through depth-first search-based topological sorting, and when a sparse ray is projected, the BOU 130 records a block ID in the DRA. Then, when information of a new ray reaches the BOU 130, the order of blocks is compared and dependency is updated. In this instance, several blocks recorded at the same depth of DRA may represent parallel blocks processible in parallel. In this way, when block order sorting is completed, a block ID to be processed is retrieved by a leading one detector starting from a low depth, thereby determining the processing order.

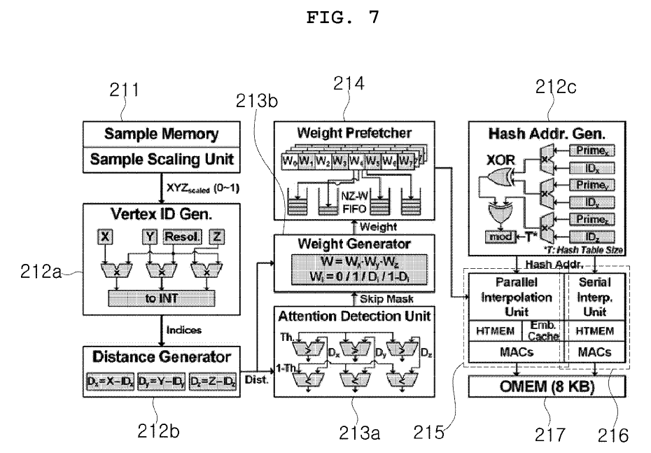

FIG. 6 and FIG. 7 are diagrams for describing a configuration of the AHIU according to an embodiment of the present invention. Referring to FIG. 6 and FIG. 7, the AHIU 210 according to the embodiment of the present invention includes a sample memory 211, a preprocessing unit 212, an attention unit 213, a weight prefetcher 214, a parallel interpolation unit (PIU) 215, a serial interpolation unit (SIU) 216, and an output memory (OMEM) 217.

In this instance, the AHIU 210 performs a two-step processing process of a preprocessing process and an interpolation process. First, in the preprocessing process, eight vertex indices (IDs) are calculated from sample coordinates for each of 3D samples, then skip vertices, which are vertices that may be skipped, are determined based on distances between the sample coordinates and the eight vertices, and information thereof is managed. In the interpolation process, a trilinear interpolation operation is performed using different heterogeneous operators for each hash embedding level including a coarse-grid level and a fine-grid level. The sample memory 211, the preprocessing unit 212, the attention unit 213, and the weight prefetcher 214 may operate as preprocessors for performing the preprocessing process. The PIU 215, the SIU 216, and the OMEM 217 may operate as interpolation operation units for an interpolation operation process.

In particular, the PIU 215 includes an embedding cache designed as a register so as to simultaneously process several inputs, and is configured to process several input addresses at once without conflict by connecting all inputs of the embedding cache to a parallel MAC, thereby operating at the coarse-grid level, and the SIU 216 includes only an HTMEM, and is configured to serially process only one address at a time using a single MAC, thereby operating at the fine-grid level.

First, the preprocessing process performs processing to omit unnecessary node operation based on a distance from a sample during trilinear interpolation.

To this end, a vertex index (vertex ID) generator 212a in the preprocessing unit 212 reads 3D coordinates generated by the SG 110 from the sample memory 211 and calculates eight vertex IDs. To this end, the vertex index (vertex ID) generator 212a may perform preset multiplication and floor operations. In this instance, a known technology may be used for an operation for calculating the vertex ID.

A distance generator 212b in the preprocessing unit 212 calculates distances between the eight vertex IDs generated by the vertex index (vertex ID) generator 212a and the sample coordinates. To this end, the distance generator 212b may perform a subtraction operation.

When all the distances are calculated, an attention detection unit 213a in the attention unit 213 identifies which vertex may be skipped, and generates a skip mask including the same. For example, when a Z-axis direction is less than a designated threshold, the attention detection unit 213a may determine that four upper vertices have little influence on a final interpolation result, and generate a skip mask including these vertices. Thereafter, a weight generator 213b in the attention unit 213 calculates a weight by multiplying three distances from each axis. Finally, a weight prefetcher 214 uses the skip mask to deliver only non-zero weight value to a FIFO.

Meanwhile, a hash address generator 212c in the preprocessing unit 212 generates a memory address of the hash table. To this end, the hash address generator 212c may perform XOR and prime number-based modulo operations, and a known technology may be used for a method of generating a memory address of the hash table.

In this way, when nodes for which interpolation operation are to be omitted are determined based on the distance from the sample through the preprocessing process, a hybrid interpolation operation is performed using the information in the interpolation operation process.

To this end, the PIU 215 processes several input addresses without conflict at once using the embedding cache to which all cache entries (for example, a total of 128 items) and parallel MACs are connected, and accesses the HTMEM (Hash Table MEMory) to perform processing only when a cache miss occurs.

On the other hand, the SIU 216, which includes only an HTMEM (Hash Table MEMory) without an embedding cache, serially processes one address at a time using a single MAC.

The OMEM 217 receives processing results from the PIU 215 and the SIU 216 and stores the processing results.

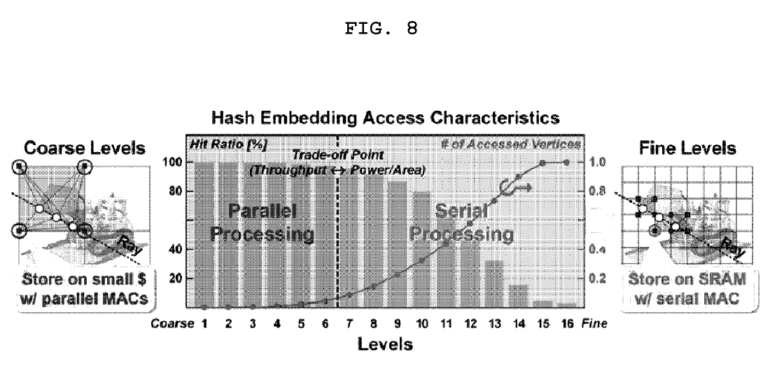

FIG. 8 is a graph illustrating memory access characteristics of a hash-based NeRF to which an interpolation unit according to an embodiment of the present invention is applied, and illustrates that the memory access characteristics differ depending on the HT level.

Referring to FIG. 8, it can be seen that the hash-based NeRF to which the present invention is applied has a different memory access pattern for each level of hash embedding. That is, the hash-based NeRF has high data reusability across several samples at coarse levels illustrated on the left side of the graph, and shows a high cache hit ratio by accessing a small number of nodes. In contrast, fine levels illustrated on the right side of the graph show opposite characteristics since different samples access different voxel grids.

The AHIU 210 illustrated in FIGS. 6 and 7 is designed to achieve low power consumption by taking advantage of these characteristics and performing parallel processing for levels having a high cache hit ratio and sequential processing for levels having a low cache hit ratio.

That is, the PIU 215 and the SIU 216 of the AHIU 210 illustrated in FIGS. 6 and 7 are proposed based on the memory access characteristics of the hash-based NeRF, as illustrated in FIG. 8. At the coarse level, the PIU 215 is implemented to store highly reusable embedding data in a small cache and maximize throughput using a parallel MAC unit, and at the fine level, the SIU 216 is implemented to store the entire embedding in an SRAM and sequentially perform interpolation operation due to low reusability.

FIG. 9 is a diagram for describing an operation process of an operation core (S³Core) to which a coarse-grained skipping method according to an embodiment of the present invention is applied, and schematically describes an operation process that accelerates an MLP operation in consideration of both similarity and sparsity between input channels by utilizing a property of the NeRF representing similar values between different inputs.

The operation process will be described as follows with reference to FIG. 9.

First, referring to FIG. 9, it is possible to observe that, when the NeRF groups adjacent samples into one input batch, these samples have similar input activation values. This property occurs since an operation pipeline of the NeRF uses 3D sample coordinates as input.

Therefore, the operation cores (S³ Cores) 220 use a skipping method that skips both similar data (data whose absolute value difference is less than or equal to a threshold) and sparse data, based on batch-wise similarity in units of input batches of the NeRF. That is, since similar data patterns and sparse data patterns appear in units of columns in an input batch direction, as illustrated in FIG. 9, in order to minimize overhead of skip control logic, the operation cores (S³ Cores) 220 apply a coarse-grained skipping method to skip the entire operation through compression for columns in which all values are 0, calculate a representative value (input activation value of a first batch) for similar columns, and reuse a result thereof for other batches.

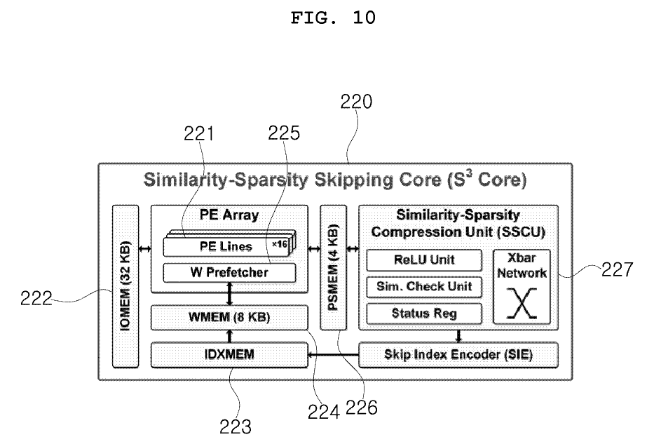

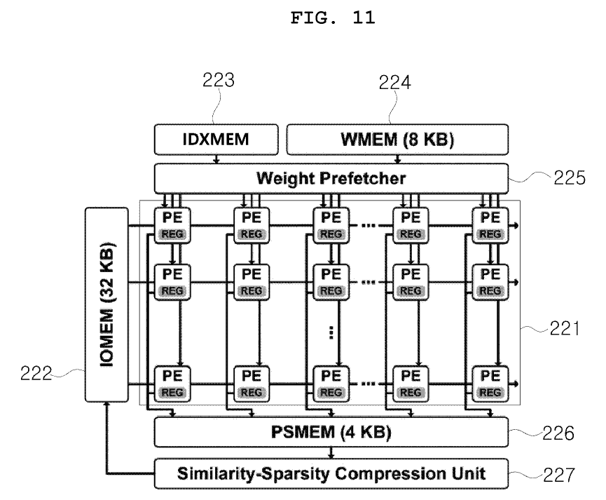

FIG. 10 and FIG. 11 are schematic block diagrams of the operation core (S³ Core) according to an embodiment of the present invention, and illustrate a core structure for supporting a coarse-grained skipping method illustrated in FIG. 9.

Referring to FIGS. 10 and 11, the operation cores (S³ Cores) 220 includes 16 x 16 processing elements (PEs) 221, an input/output memory (IOMEM) 222 including two bank groups to simultaneously perform input and output, an index memory (IDXMEM) 223 that stores a skip index, which is an index of an input channel skipped in a previous layer, a weight memory (WMEM) 224 that stores a weight of an input channel, a weight prefetcher 225 that preloads only a weight of an input channel not skipped from the WMEM 224 based on the skip index and supplies the preloaded weight to the PEs 221 when replacing the weight, a partial sum memory (PSMEM) 226 that accumulates partial sums by a MAC operation using an addition tree in units of columns of the PEs 221, and a unit 227 for supporting skipping.

In this instance, the operation cores (S³ Cores) 220 adopt a weight stationary (WS) architecture that uses the 16 x 16 processing elements (PEs) 221 to maximize data reuse while processing several batches, thereby processing a different input batch each cycle.

In particular, the IOMEM 222 may simultaneously read input (IA) and write output (OA) by including two bank groups. In addition, compressed IA of a previous layer in the IOMEM 222 is input to sixteen PE 221 lines, and broadcast to all PEs in each PE line to enable input reuse.

The weight prefetcher 225 loads only a weight of an input channel not skipped in the WMEM 225 according to the skip index of the IDXMEM 223. In the sixteen PE 221 lines, when the MAC operation using the addition tree is completed, the partial sum is accumulated in the PSMEM 224, and a final result is transferred to a unit for supporting skipping (aka, similarity-sparsity compression unit, hereinafter referred to as "SSCU") 227.

In this instance, the unit for supporting skipping (aka, SSCU) 227 analyzes similarity and sparsity of a result accumulated in the PSMEM 226, compresses the result accumulated in the PSMEM 226 based on a result thereof, and stores the result in the IOMEM 222.

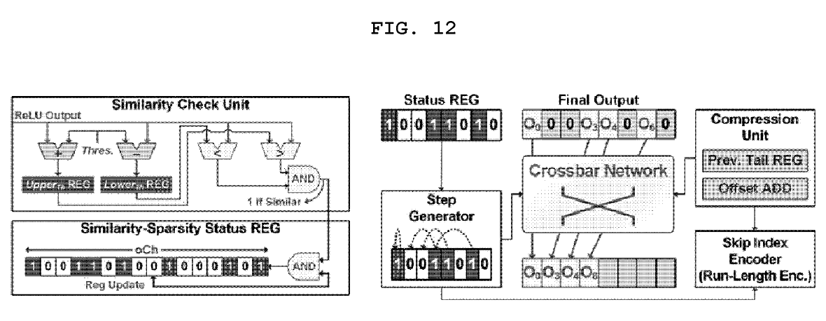

An operation and a configuration of the SSCU 227 are more specifically illustrated in FIG. 12.

FIG. 12 is a diagram for describing the operation and the configuration of the SSCU according to an embodiment of the present invention. Referring to FIGS. 10 and 12, the SSCU 227 may compress and store a matrix in an uncompressed state according to similarity and sparsity patterns in order to support the coarse-grained skipping method. To this end, the SSCU 227 needs to detect similarity/sparsity for all batches, and in order to omit unnecessary operations during MLP operations based thereon, the SSCU 227 may be implemented to include a similarity check unit that compares a result accumulated in the PSMEM with a preset similarity range, a state register that stores a processing result of the similarity check unit, a step generator that calculates the number of steps for compression using information stored in the state register, and a crossbar network that converts the result accumulated in the PSMEM into a compressed form based on information stored in the state register and the number of steps.

An operation of the SSCU 227 is described as follows. First, the SSCU 227 compares output from a ReLU unit with a similarity range predefined by a representative value. When the output is within a similarity range, a current similarity state is maintained in the register, and otherwise, the state register is reset to 0 through an AND operation. When a similarity/sparseness detection step is completed in this way, the final state register is transferred to the step generator to calculate the number of steps for compression. Thereafter, the crossbar network converts a final output into a compressed form, which is written again to the IOMEM 222 to perform layer fusion, thereby reducing off-chip memory access. In particular, in order to achieve high MAC utilization, all matrix multiplications and SSCU operations may be pipelined and operated without stalling of a data path. In this instance, the area and power ratio of the SSCU 227 are 7.0% and 1.1%, respectively, which means overhead is significantly low.

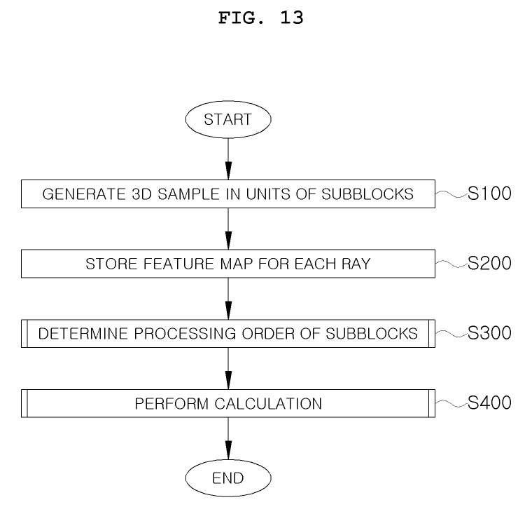

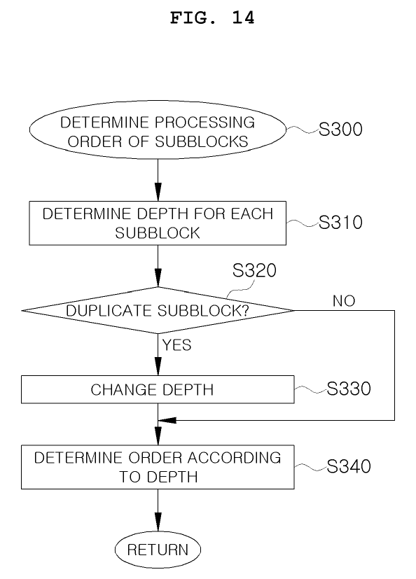

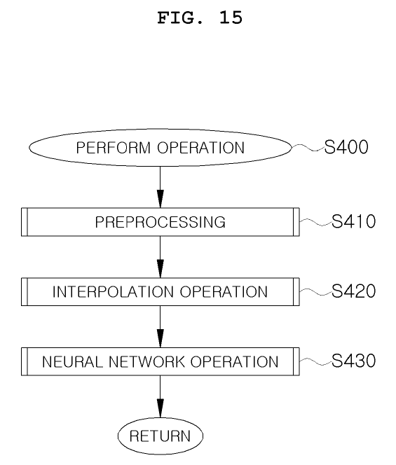

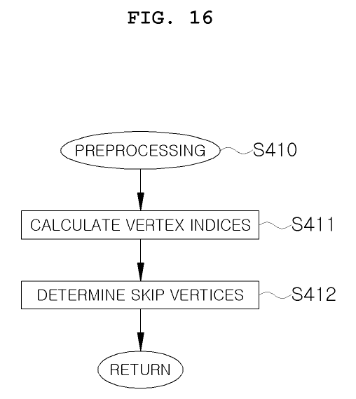

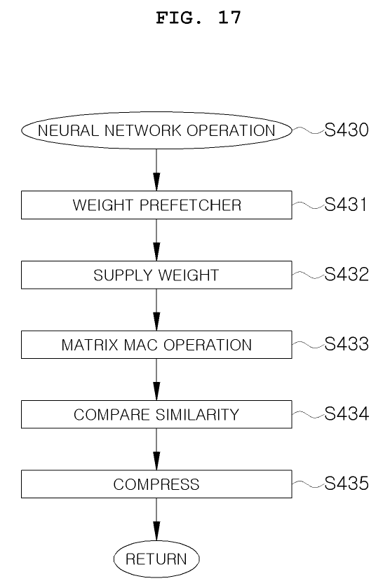

FIG. 13 to FIG. 17 are processing flowcharts for an energy-efficient neural graphics acceleration method according to an embodiment of the present invention. The energy-efficient neural graphics acceleration method according to the embodiment of the present invention will be described as follows with reference to FIGS. 1 to 17.

First, in step S100, the SG 110 divides a virtual 3D space into a plurality of subblocks, and then generates a 3D sample in units of subblocks. To this end, in step S100, the SG 110 generates a sample for the 3D space, and generates sample coordinates through ray casting while checking a valid space using a hierarchical bitmap that encodes a coarse bitmap indicating an occupancy state of each of the subblocks, and a fine bitmap for an interior of the subblocks.

In step S200, the neural graphics accelerator of the present invention stores a feature map for each ray, which is information on a plurality of subblocks through which one ray passes for ray casting, in the RAT 120.

To this end, in step S200, the neural graphics accelerator may store dynamically allocated address information for the feature map for each ray using a linked list format.

In addition, in step S200, the neural graphics accelerator may compress and store address information allocated to each of a plurality of rays grouped into patches in units of patches.

In step S300, the BOU 130 determines the processing order of each of the subblocks through depth-first search-based topological sorting. To this end, in step S310, the BOU 130 determines a depth of each of the subblocks through sparse ray casting. In steps S320 and S330, in the case of a duplicate subblock which is a subblock through which one or more rays pass, the BOU 130 changes a deeper value among depths determined by one or more rays, respectively, to a depth of the duplicate subblock. In step S340, the BOU 130 determines the order of each subblock according to the depth thereof, and determines the processing order so that the subblock having the lower depth is processed first.

In this instance, steps S100 to S300 may be performed in parallel.

In step S400, the core cluster 200 performs operations for modeling and rendering the 3D samples. In particular, in step S400, hash encoding and neural network operations are performed.

To this end, in step S410, the AHIU 210 performs preprocessing with skipping vertices applied to the 3D samples, in step S420, the AHIU 210 performs a trilinear interpolation operation using the heterogeneous operator, and in step S430, the operation cores (S³Cores) 220 performs a neural network operation that accelerates both modeling and rendering by skipping all input channels whose values are all 0 or all similar using a coarse-grained skipping operation method.

In particular, for the preprocessing (step S410), the AHIU 210 calculates eight vertex indices (IDs) from sample coordinates for each of the 3D samples in step S411, and determines skip vertices which are vertices that may be skipped by distances between the sample coordinates and the eight vertices in step S412. As a result, the AHIU 210 may generate a skip mask.

In addition, for the interpolation operation (step S420), the AHIU 210 performs a trilinear interpolation operation using different heterogeneous operators for each hash embedding level including a coarse-grid level and a fine-grid level, and simultaneously performs parallel interpolation that processes all inputs of the embedding cache in parallel without conflict at the coarse-grid level using an embedding cache designed as a register to simultaneously process several inputs and serial interpolation for serially processing only one address at a time at the fine-grid level using an HTMEM and a single MAC.

Meanwhile, for the neural network operation (step S430), the operation cores (S³ Cores) 220 performs a weight prefetcher that preloads a weight of an input channel not skipped in a previous layer in step S431, supplies the preloaded weight to the PEs when replacing weights of the PEs 221 included in the neural graphics accelerator in step S432, performs a matrix MAC operation using the weights by the PEs 221 in step S433, determines similarity and sparsity by comparing partial sums calculated in units of columns of the PEs 221 included in the neural graphics accelerator with a preset similarity range in step S434, and converts the partial sums into a compressed form based on a processing result of step S434 in step S435.

In the description of the method of the present invention with reference to FIGS. 1 to 17, redundant description of content mentioned in the description of the neural graphics accelerator of the present invention with reference to FIGS. 1 to 12 has been omitted.

In this way, the present invention improves a memory access inefficiency and the amount of operation of a neural graphics algorithm, thereby making it possible to train a DNN using several 2D images to instantly create a 3D model and render the 3D model in real time.

In addition, the present invention divides hash embedding of each level into several segments so that the divided segments may be completely stored in an on-chip memory of an edge-oriented GPU, thereby converting irregular hash embedding access into regular hash embedding access to allow pruning of hash embedding that has been unnecessarily used in an empty space. As a result, there are advantages of being able to improve memory efficiency by significantly reducing memory usage and improve a memory access inefficiency by minimizing external memory access. In particular, the present invention has an effect of being able to reduce external memory access by 66% using a method of dividing hash embedding into several segments as described above.

In addition, the present invention has an advantage of being able to process hash embedding in units of segments in parallel due to reduction in memory usage as described above, thereby shortening rendering/modeling operation time to enable rapid acceleration of a NeRF model based on hash encoding even in edge and mobile environments. In particular, the present invention has an effect of being able to reduce the rendering operation time by 58.8% due to pipelining between operations that may be performed through parallel operations.

In addition, the present invention has an advantage of being able to increase throughput by skipping operation for a node contributing less to a final result based on approximate properties of trilinear interpolation. For example, the present invention calculates distances between a currently operated sample and each of eight nodes during trilinear interpolation, and determines that a node contributes less to a final result value according to characteristics of an interpolation method and omits operation of the corresponding node when the distance is greater than a certain reference value, thereby being able to increase throughput by 1.51 times.

In addition, the present invention has advantages in that it is possible to process operation by a different operation unit for each level of hash embedding during a trilinear interpolation operation of hash encoding by applying a heterogeneous operator, maximize data reuse through parallel processing using a cache at a coarse-grid level, and perform serial processing without using a cache at a fine-grid level, thereby maximizing data reuse, alleviating bank conflict, and, as a result, solving a problem of throughput degradation caused by bank conflict.

In addition, the present invention has an advantage in that, in the case of the NeRF, since input batches have similar 3D coordinate values, similarity between several inputs having similar input values is utilized in subsequent MLP layers to skip all operations on similar data and rare data, thereby being able to reduce the amount of operation. In addition, in this instance, the present invention has an advantage in that energy efficiency may be increased by providing an MLP core to which a coarse-grained skipping method is applied during MLP operation. As a result, the present invention may optimize a memory access pattern for each level of hash embedding, and as a result, has a feature of enabling low-power operation by reducing power consumption by 56.4% when compared to the existing operation unit design method. In addition, as a result, the present invention may achieve 1.42 times higher rendering throughput and 1.61 times higher modeling energy efficiency by omitting not only operation on similar values but also operation on 0.

In particular, the present invention has been implemented to enable 3D modeling and rendering with high energy efficiency and low power even in an edge/mobile environment with limited resources by optimizing the existing inefficient memory access and the large amount of operation. In this way, the present invention may be utilized in various applications such as avatar creation, automated robots, AR/VR applications, and online shopping in edge/mobile devices such as AR/VR devices, so that it can be considered that an added value that may be extracted by the present invention is large and marketability thereof is high.

As described above, an energy-efficient neural graphics accelerator and a method thereof provided by the present invention have advantages in that instantaneous 3D modeling and high-speed rendering are simultaneously possible even in an edge/mobile environment having limited resources by improving a memory access inefficiency and the amount of operation of a neural graphics algorithm.

In addition, the present invention divides hash embedding of each level into several segments so that the divided segments may be completely stored in an on-chip memory of an edge-oriented GPU, thereby converting irregular hash embedding access into regular hash embedding access to allow pruning of hash embedding that has been unnecessarily used in an empty space. As a result, there are advantages of being able to improve memory efficiency by significantly reducing memory usage and improve a memory access inefficiency by minimizing external memory access.

In addition, the present invention has an advantage of being able to process hash embedding in units of segments in parallel due to reduction in memory usage as described above, thereby shortening rendering/modeling operation time to enable rapid acceleration of a NeRF model based on hash encoding even in edge and mobile environments.

In addition, the present invention has an advantage of being able to increase throughput by skipping operation for a node contributing less to a final result based on approximate properties of trilinear interpolation.

In addition, the present invention has advantages in that it is possible to process operation by a different operation unit for each level of hash embedding during a trilinear interpolation operation of hash encoding by applying a heterogeneous operator, maximize data reuse through parallel processing using a cache at a coarse-grid level, and perform serial processing without using a cache at a fine-grid level, thereby maximizing data reuse, alleviating bank conflict, and, as a result, solving a problem of throughput degradation caused by bank conflict.

In addition, the present invention has an advantage in that, in the case of the NeRF, since input batches have similar 3D coordinate values, similarity between several inputs having similar input values is utilized in subsequent MLP layers to skip all operations on similar data and rare data, thereby being able to reduce the amount of operation. In addition, in this instance, the present invention has an advantage in that energy efficiency may be increased by providing an MLP core to which a coarse-grained skipping method is applied during MLP operation.

Even though the description has been given by presenting and describing preferred embodiments of the present invention, the present invention is not necessarily limited thereto, and those skilled in the art to which the present invention pertains will easily understand that various substitutions, modifications, and changes may be made within the scope not departing from the technical spirit of the present invention.

What is claimed is:

1. A neural graphics accelerator configured to accelerate a three-dimensional (3D) image using a neural radiance field (NeRF) model based on hash encoding, the neural graphics accelerator comprising:
a spatial management unit (SMU) configured to divide a virtual 3D space into a plurality of subblocks, and then generate, store, and manage 3D samples in units of subblocks; and
n core clusters (here, n is a natural number, which is applied hereinafter) configured to acquire color and density for each of the 3D samples by performing modeling and rendering on the 3D samples,
wherein each of the core clusters comprises:
an attention-based hybrid interpolation unit (referred to hereinafter as "AHIU") configured to perform hash encoding on the 3D samples through preprocessing with skipping vertices applied to the 3D samples and a trilinear interpolation operation using a heterogeneous operator; and
m operation cores (S³ Cores) configured to skip all input channels whose values are all 0 or input channels all having similar values by a coarse-grained skipping operation to accelerate both modeling and rendering, thereby calculating color and density of each of the 3D samples.

2. The neural graphics accelerator according to claim 1, wherein the SMU comprises:
a plurality of sample generators (SGs) configured to generate a sample for the 3D space and generate sample coordinates through ray casting while checking a valid space using a coarse bitmap representing an occupancy state of each of the subblocks and a hierarchical bitmap for encoding a fine bitmap for an interior of the subblocks;
a ray address table (RAT) configured to store a feature map for each ray, which is information on a plurality of subblocks through which one ray passes for the ray casting; and
a block ordering unit (BOU) configured to determine a processing order of each of the subblocks through depth-first search-based topological sorting.

3. The neural graphics accelerator according to claim 2, wherein the RAT stores address information dynamically allocated to the feature map for each ray using a linked list format.

4. The neural graphics accelerator according to claim 3, wherein the RAT compresses and stores address information allocated to each of a plurality of rays grouped into patches in units of patches.

5. The neural graphics accelerator according to claim 2, wherein the BOU determines a depth of each of the subblocks through sparse ray casting, and then determines a processing order to process a subblock having a lower depth first.

6. The neural graphics accelerator according to claim 5, wherein, in a case of a duplicate subblock that is a subblock through which one or more rays pass, the BOU determines a deeper value among depths determined by the one or more rays, respectively, as a depth of the duplicate subblock.

7. The neural graphics accelerator according to claim 1, wherein the AHIU comprises:
a preprocessor configured to calculate eight vertex indices (IDs) from sample coordinates for each of the 3D samples, then determine skip vertices which are vertices allowed to be skipped by distances between the sample coordinates and the eight vertices, and manage information thereof; and
an interpolation operation unit configured to perform a trilinear interpolation operation using different heterogeneous operators for each hash embedding level including a coarse-grid level and a fine-grid level.

8. The neural graphics accelerator according to claim 7, wherein the interpolation operation unit comprises:
a parallel interpolation unit including an embedding cache designed as a register so as to simultaneously process several inputs, and configured to process several input addresses at once without conflict by connecting all inputs of the embedding cache to a parallel MAC, thereby operating at the coarse-grid level; and
a serial interpolation unit exclusively including an HTMEM (Hash Table MEMory), and configured to serially process one address at a time using a single MAC, thereby operating at the fine-grid level.

9. The neural graphics accelerator according to claim 7, wherein each of the operation cores (S³Cores) comprises:
16 x 16 processing elements (PEs);
an input/output memory (IOMEM) including two bank groups to simultaneously perform input and output;
an index memory (IDXMEM) configured to store a skip index, which is an index of an input channel skipped in a previous layer;
a weight memory (WMEM) configured to store a weight of an input channel;
a weight prefetcher configured to preload a weight of an input channel not skipped from the WMEM based on the skip index and supply the preloaded weight to the PEs when replacing the weight;
a partial sum memory (PSMEM) configured to accumulate partial sums by a MAC operation using an addition tree in units of columns of the PEs; and
a similarity-sparsity compression unit (SSCU) configured to analyze similarity and sparsity of a result accumulated in the PSMEM, compress the result accumulated in the PSMEM based on a result thereof, and store the result in the IOMEM.

10. The neural graphics accelerator according to claim 9, wherein the SSCU comprises:
a similarity check unit configured to compare a result accumulated in the PSMEM with a preset similarity range;
a state register configured to store a processing result of the similarity check unit;
a step generator configured to calculate a number of steps for compression using information stored in the state register; and
a crossbar network configured to convert the result accumulated in the PSMEM into a compressed form based on information stored in the state register and the number of steps.

11. A method of accelerating neural graphics using a neural graphics accelerator configured to accelerate a 3D image using a NeRF model based on hash encoding, the method comprising:
generating, by the neural graphics accelerator, 3D samples in units of subblocks after dividing a virtual 3D space into a plurality of subblocks;
storing, by the neural graphics accelerator, a feature map for each ray which is information on a plurality of subblocks through which one ray passes for ray casting;
determining, by the neural graphics accelerator, a processing order of each of the subblocks through depth-first search-based topological sorting; and
performing, by the neural graphics accelerator, modeling and rendering on the 3D samples,
wherein the performing modeling and rendering comprises:
performing preprocessing with skipping vertices applied to the 3D samples;
performing a trilinear interpolation operation using a heterogeneous operator; and
accelerating both modeling and rendering by skipping all input channels whose values are all 0 or input channels all having similar values by a coarse-grained skipping operation.

12. The method according to claim 11, wherein the generating 3D samples comprises generating a sample for the 3D space and generating sample coordinates through ray casting while checking a valid space using a coarse bitmap representing an occupancy state of each of the subblocks and a hierarchical bitmap for encoding a fine bitmap for an interior of the subblocks.

13. The method according to claim 12, wherein the storing a feature map for each ray comprises storing address information dynamically allocated to the feature map for each ray using a linked list form.

14. The method according to claim 13, wherein the storing a feature map for each ray comprises compressing and storing address information allocated to each of a plurality of rays grouped into patches in units of patches.

15. The method according to claim 11, wherein the determining a processing order comprises:
determining a depth of each of the subblocks through sparse ray casting; and
determining a processing order to process a subblock having a lower depth first.

16. The method according to claim 15, wherein, in a case of a duplicate subblock that is a subblock through which one or more rays pass, the determining a processing order further comprises changing a deeper value among depths determined by the one or more rays, respectively, to a depth of the duplicate subblock.

17. The method according to claim 11, wherein the performing preprocessing comprises:
calculating eight vertex indices (IDs) from sample coordinates for each of the 3D samples; and
determining skip vertices which are vertices allowed to be skipped by distances between the sample coordinates and the eight vertices.

18. The method according to claim 11, wherein:
the performing a trilinear interpolation operation comprises performing a trilinear interpolation operation using different heterogeneous operators for each hash embedding level including a coarse-grid level and a fine-grid level, and
the performing a trilinear interpolation operation comprises:
using an embedding cache designed as a register to allow several inputs to be simultaneously processed, thereby processing all inputs of the embedding cache in parallel without conflict at the coarse-grid level; and
serially processing one address at a time at the fine-grid level using an HTMEM and a single MAC.

19. The method according to claim 11, wherein the accelerating both modeling and rendering comprises:
determining similarity and sparsity by comparing partial sums calculated in units of columns of PEs included in the neural graphics accelerator with a preset similarity range; and
converting the partial sums into a compressed form based on a processing result in the determining similarity and sparsity.

20. The method according to claim 19, wherein the accelerating both modeling and rendering further comprises:
preloading a weight of an input channel not skipped in a previous layer; and
supplying the preloaded weight to the PEs when replacing weights of the PEs included in the neural graphics accelerator.
